(19) United States
(12) Patent Application Publication
(10) Pub. No.: US 2016/0309097 A1
(43) Pub. Date: Oct. 20, 2016

(54) CYLINDER HEAD ASSEMBLY

(71) Applicant: Dr. Ing. h.c. F. Porsche Aktiengesellschaft, Stuttgart (DE)

(72) Inventor: Maximilian Fischer, Tamm (DE)

(21) Appl. No.: 15/071,776

(22) Filed: Mar. 16, 2016

(30) Foreign Application Priority Data
Apr. 17, 2015 (DE) 10 2015 105 920.7

(51) Int. Cl. H04N 5/33; H04N 5/225; G01J 5/08; G02B 13/14; G02B 7/00; F02F 1/24; G02B 13/00

(52) U.S. Cl. CPC H04N 5/33; F02F 1/24; H04N 5/2252; H04N 5/2254; G02B 13/0095; G02B 13/14; G02B 7/008; G01J 5/08; G01J 2005/0081

(57) ABSTRACT

A cylinder head (10) for an internal combustion engine has a housing (12) that is assigned a multiplicity of elements (18). An optical channel (20) is formed in the housing (12) and is assigned to at least one of the elements (18). The optical channel (20) is assigned a thermography camera (26) that is designed to detect infrared radiation (28) from the at least one element (28) through the optical channel (20) to make available a thermography image (52) of the at least one element (18).

### CROSS REFERENCE TO RELATED APPLICATION

This application claims priority under 35 USC 119 to German Patent Appl. No. 10 2015 105 920.7 filed on Apr. 17, 2015, the entire disclosure of which is incorporated herein by reference.

### BACKGROUND

1. Field of the Invention

The invention relates to a cylinder head assembly for an internal combustion engine. The cylinder head assembly has a housing with a multiplicity of elements. An optical channel is formed in the housing and is assigned to at least one of the elements. The invention also relates to a method for detecting a temperature of an element of an internal combustion engine. The invention further relates to an internal combustion engine for a motor vehicle with an engine block that has at least one cylinder and one piston.

2. Description of the Related Art

Legal requirements and customer demands have led to motor vehicles with lower consumption internal combustion engines that have a continuously increasing specific engine power. Increased power densities lead to an increase amount of thermal energy that is conducted away as waste heat from the combustion chamber into the cooling system and the surroundings. The thermal loading of a large number of components of the internal combustion engine also increases as a result of this increased waste heat. More particularly, elements such as pistons, valves, cylinder head, exhaust gas and turbochargers experience increased thermal loading.

The increased thermal loading usually is counteracted by increased cooling, structural measures and the use of relatively high value materials to ensure the reliability of the engines. In this context, structural measures involving more cost-effective and higher value materials are more expensive but generally entail lower design complexity.

The development of internal combustion engines should take into account the heating of elements, such as pistons, in the real engine operation to avoid exceeding specific temperature limits. Any structural change can result in changing the temperature of certain components during operation. Thus, continuous determination of the temperature of certain components in the development phase is necessary.

The hardness of certain materials changes with changes in temperature, and these materials can be used in certain elements, such as pistons, in the real engine operation. Changes in the material hardness of these elements then is determined and permits conclusions to be drawn about the operating temperatures. Furthermore, thermo-elements also are integrated into specific elements of the internal combustion engine to measure changes in temperature during operation.

A disadvantage with the known method is that the temperature measuring range is small, the measuring accuracy is low and the technical complexity involved in measuring the temperature is high. Additionally, the temperature measurement often cannot take place under real conditions, and, hence, there is a lack of certainty with respect to the measured operating temperatures.

Objects of the invention are to provide a cylinder head assembly that enables a temperature of an element to be measured precisely under real conditions and to provide a method for measuring a temperature of an element in an internal combustion engine.

### SUMMARY

This invention relates to a cylinder head assembly with an optical channel and a thermography camera that is designed to detect infrared radiation from at least one element through the optical channel and to provide a thermography image of the at least one element. The invention also relates to a method where infrared radiation of an element is detected through the optical channel. The optical channel may be formed in a housing of the cylinder head assembly, and a thermography image of the at least one element may be made available by means of a thermography camera. The invention also relates to an internal combustion engine with the cylinder head assembly described herein.

The infrared radiation of the element to be measured is detected by the thermography camera through the optical channel of the cylinder head assembly and a corresponding thermography image is made available by the thermography camera. Thus, the temperature of the element to be measured can be determined in a contactless fashion. Additionally, the projection of the infrared radiation onto the thermography camera enables a detection and, if appropriate, reduction of influences owing to lateral residual irradiation or reflected infrared radiation. Thus, the invention permits precise temperature measurement of elements of the cylinder head assembly and/or elements of the combustion chamber of the internal combustion engine under real conditions. In addition, the pyrometric measurement provides a high level of accuracy and at the same time a large temperature range in which the temperature of the element can be determined. As a result, precise temperature measurement is possible in the real engine operating mode and at the same time temperature distribution in the real engine operating mode can be determined.

In one embodiment, the optical channel is a linear channel and has at an axial end an opening that is assigned to the at least one element. As a result, the infrared radiation of the at least one element can be detected precisely without infrared radiation from other components of the cylinder head assembly influencing the measurement.

A transparent seal element may be assigned to the optical channel to seal the optical channel with respect to the at least one element in a gastight fashion. As a result, elements of the cylinder head assembly and/or the combustion chamber of the internal combustion engine that are arranged in a region with highly fluctuating pressures can be measured with little technical complexity.

An optical unit may be arranged in the optical channel and may be designed to project infrared radiation onto the thermography camera. As a result, a corresponding thermography image of the at least one element in the cylinder head assembly or of the combustion chamber can be made available by the thermography camera. Thus, the temperature distribution can be measured in a region of the internal combustion engine or of the cylinder head assembly.

The optical unit may have a rod lens system so that an endoscope-like optical unit can be arranged in the optical channel. Thus, the thermography image can be detected by the thermography camera over a relatively large distance, thereby permitting the infrared radiation to be projected through the cylinder head assembly. As a result, an infrared projection in the real engine operating mode is possible.

The optical unit may have a multiplicity of sapphire lenses. As a result, the infrared radiation can be projected onto the thermography camera through the optical unit.

The optical channel may be a linear tube with a gastight and fluid tight lateral surface. As a result, the optical channel can be arranged in the cylinder head through oil chambers and/or cooling water chambers. Thus, infrared measurement can be made at difficult to access positions in the cylinder head and/or the internal combustion engine. This arrangement enables the optical channel, the elements therein and the thermography camera to be protected against thermal influences from the combustion chamber of the internal combustion engine, thereby permitting reliable temperature measurement.

The cooling assembly may be connected to a cooling unit of the cylinder head. As a result, the optical channel may be cooled continuously with little technical complexity.

The cooling assembly of the optical channel may be a fluid cooling means. As a result, effective cooling of the optical channel is possible with little technical complexity.

The thermography camera may be connected to an electronic evaluation unit that is designed to determine a temperature of at least a part of the thermography image. As a result, a measuring range can be selected precisely and dynamic behavior of the one element in the cylinder head assembly and/or in the combustion chamber can be observed to determine precisely the temperature of the at least one part.

The thermography camera may have a recording frequency of more than 10 000 images per second. As a result, dynamic processes in the cylinder head assembly and/or the combustion chamber of the internal combustion engine can be followed precisely at high engine rotational speeds.

Overall, the inventive cylinder head assembly, the method according to the invention and the internal combustion engine according to the invention permit precise and detailed determination of the thermal conditions in the cylinder head and/or the combustion chamber of the internal combustion engine, with the result that comprehensive thermal analysis is possible in the real engine operating mode.

Of course, the features that are mentioned above and those that are still to be explained below can be used in the respective specified combination and also in other combinations or alone without departing from the scope of the present invention.

Exemplary embodiments of the invention are illustrated in the drawings and are explained in more detail in the following description.

### BRIEF DESCRIPTION OF THE DRAWINGS

FIG. 1 shows a schematic sectional view through a cylinder head assembly having an optical channel and a thermography camera for temperature measurement.

FIG. 2 shows a schematic flowchart explaining the temperature measurement by means of the thermography camera.

FIG. 3 shows a thermography image of a combustion chamber with a temperature profile at two different regions in the combustion chamber of the internal combustion engine.

### DETAILED DESCRIPTION

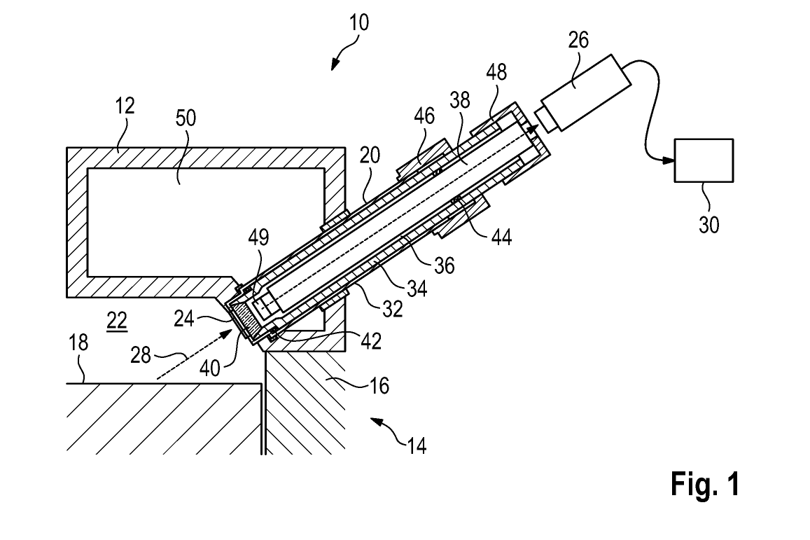

FIG. 1 illustrates a schematic partial view of a cylinder head assembly and is generally denoted by 10. The cylinder head assembly 10 has a housing 12 that delimits the cylinder head assembly 10 toward the outside. The cylinder head assembly 10 is connected to an engine block 14 that is illustrated only schematically in a partial view in FIG. 1. The engine block 14 has at least one cylinder 16 in which at least one piston 18 is accommodated. The thermal loading of the piston 18 is very high as a result of the high power densities of modern internal combustion engines. As a result, the real operating temperature of the piston and its surface have to be measured regularly during the development phase to avoid excessively high thermal loading during operation of the end.

The cylinder head assembly of FIG. 1 also has an optical channel 20 formed in the housing 12 and has an opening 24 assigned to a combustion chamber 22 of the engine block 14. The optical channel 20 is connected optically to a thermography camera 26 so that infrared radiation 28 emitted by the piston 18 can be detected through the optical channel 20. The thermography camera 26 is connected to a control unit 30 that is designed to control the thermography camera 26, to evaluate the thermography image that is made available and to determine at least one temperature in the combustion chamber 22 or at the piston 18 on the basis of the thermography image.

The optical channel 20 has a cladding tube 32 that forms an outer lateral surface of the optical channel 20 and in which an inner tube 34 is accommodated. The inner tube 34 has a water cooling means 36 that is designed to cool the inner tube 34 and an optical unit 38 accommodated therein. A sealing element 40 closes off the opening 24 of the inner tube 34 from the combustion chamber 22 in a gastight fashion. The sealing element 40 is permeable or transparent to infrared beams and is preferably formed from sapphire glass.

The inner tube 34 is sealed in the cladding tube 32 by a sealing ring 42, and the optical unit 38 is mounted in a sprung fashion in the inner tube 34 by dampers 44. The cladding tube 32 is closed off on a side lying opposite the opening 24 by a cladding nut 46, wherein the inner tube 34 is closed off at an end lying opposite the opening by a cladding nut 48. A thermal element 49 is arranged in the inner tube 34 to detect a temperature of the optical unit 38.

The optical unit 38 is a rod lens system with endoscopic properties to project the infrared radiation 28 as far as the thermography camera 26 via the elongated optical channel 20. The rod lens system has lenses that are correspondingly permeable to the infrared radiation 28 and preferably are formed from sapphire. The lenses each have a cut edge or surface curvature that is adapted to the refraction in the infrared spectrum of the infrared beams 28. The rod lens system makes it possible to project the infrared rays 28 onto the thermography camera 26 through the small opening 24 and to make available a corresponding infrared image of the combustion chamber 22.

The sealing element 40, which preferably is formed from sapphire, is arranged in the opening to screen the rod lens system of the optical unit 38 from the combustion chamber 22 and in particular from the temperature conditions and pressure conditions in the combustion chamber 22. Furthermore, the cladding tube 32 and/or the inner tube 34 is connected to a fluid cooling means 36. As a result, the entire optical channel 20 with all the elements can be protected against thermal overloading.

The thermography camera 26 has a detector that can detect the entire infrared spectral range and also has a filter that transmits a specific wavelength range of the infrared spectrum depending on the application. As a result, the sensitivity of the thermography camera 26 can be adapted to the material to be measured. In this context, the wavelengths between 1.4 μm and 1.8 μm are preferred for steel and 1.8 μm to 2.2 μm for plastic. In addition, various wavelength ranges can be detected and compared by means of different filters. In addition, by adapting the spectral range it is possible to adapt the temperature measuring range and to make the measurement more precise.

The thermography camera 26 preferably has the highest possible resolution, in particular 1280×1024 or higher, and a high recording frequency of more than 10 000 images per second (FPS) at the highest possible residual resolution. As a result, dynamic processes in the combustion chamber 22 can be mapped even at high engine rotational speed and the temperature correspondingly detected.

The control unit 30 is designed to evaluate the thermography image that is made available by a thermography camera 26. In this context, one or more measuring ranges can be defined in the thermography image manually or automatically and a temperature profile can be determined at the selected regions by means of the detected infrared radiation 28. As a result, precise temperature measurement in the combustion chamber 22 is possible. Thus, shadowing effects and scattered radiation can be detected and, if appropriate, avoided by corresponding selection of the measuring range.

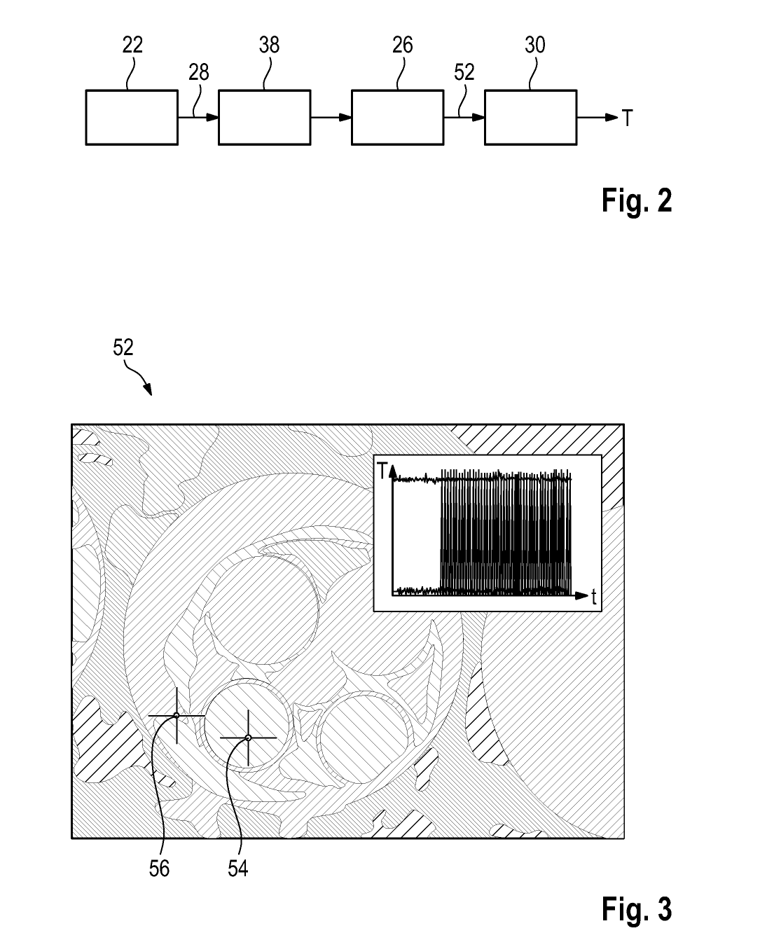

FIG. 2 is a schematic diagram of a measuring chain of the cylinder head assembly 10 for measuring the temperature T in the combustion chamber 22. The infrared radiation 28 from the combustion chamber 22 is projected in an endoscope-like manner through the optical unit 38 onto the thermography camera 26. The thermography camera 26 makes available the thermography image 52 and transmits it to the control unit 30. The control unit 30 evaluates the thermography image 52, defines different measuring ranges in the thermography image 52 and detects the temperature T or the temperature profile at the defined measuring ranges and makes it available as a measured value.

As a result, precise temperature measurement of different regions in the combustion chamber 22 is possible.

FIG. 3 illustrates the thermography image 52 that is made available to the control unit 30 by the thermography camera 26. The control unit 30 defines different measuring ranges in the thermography image 52, specifically a first range 54 and a second range 56, and detects a temperature profile T(t) in these ranges 54, 56 by means of the corresponding infrared radiation 28 in these ranges 54, 56, as illustrated in FIG. 3.

As a result, the temperature T can be detected precisely at any desired points or in any desired regions of the combustion chamber and corresponding evaluated.

Overall, the cylinder head assembly 10 with the optical channel 20 and the thermography camera 26 makes available precise temperature measurements of the combustion chamber 22 or an element 18 of the cylinder head assembly 10 of a motor vehicle.

What is claimed is:

1. A cylinder head for an internal combustion engine, comprising:
a housing having a multiplicity of elements;
an optical channel formed in the housing and assigned to at least one of the elements; and
a thermography camera communicating with the optical channel and configured to detect infrared radiation from the at least one element through the optical channel and to make available a thermography image of the at least one element.

2. The cylinder head assembly of claim 1, wherein the optical channel is a linear channel with an opening at one axial end being assigned to the at least one element.

3. The cylinder head assembly of claim 1, further comprising a transparent sealing element that seals the optical channel in a gastight fashion with respect to the at least one element.

4. The cylinder head assembly of claim 1, further comprising an optical unit arranged in the optical channel and configured to project the infrared radiation onto the thermography camera.

5. The cylinder head assembly of claim 4, wherein the optical unit is a rod lens system.

6. The cylinder head assembly of claim 4, wherein the optical unit has a multiplicity of sapphire lenses.

7. The cylinder head assembly of claim 1, wherein the optical channel is a linear tube and has a gastight and fluid tight lateral surface.

8. The cylinder head assembly of claim 1, wherein the optical channel has a cooling assembly to cool the optical channel.

9. The cylinder head assembly of claim 1, wherein the thermography camera is connected to an electronic evaluation unit that determines a temperature of at least one region of the thermography image.

10. The cylinder head assembly of claim 1, wherein the thermography camera has a recording frequency of more than 10 000 images per second.

11. A method for detecting a temperature of an element of a cylinder head assembly of an internal combustion engine, the method comprising: providing an optical channel in a housing of the cylinder head assembly so that a first end of the optical channel communicates visually with the element of the cylinder head assembly and so that a second end of the optical channel is external of the housing, using a thermography camera in proximity to the second end of the optical channel for detecting infrared radiation of the element through the optical channel; and producing a thermography image of the element.

12. An internal combustion engine for a motor vehicle, having an engine block with at least one cylinder and one piston, and having the cylinder head assembly of claim 1.
